(19) United States
(12) Patent Application Publication
(10) Pub. No.: US 2023/0221128 A1
(43) Pub. Date: Jul. 13, 2023

(54) Graph Exploration for Rulebook Trajectory Generation

(71) Applicant: Motional AD LLC, Boston, MA (US)

(72) Inventors: Anne Collin, Cambridge, MA (US); Hsun-Hsien Chang, Brookline, MA (US); Radboud Duintjer Tebbens, Winchester, MA (US); Calin Belta, Sherborn, MA (US); Amitai Bin-Nun, Silver Spring, MD (US); Noushin Mehdipour, Allston, MA (US)

(21) Appl. No.: 17/573,001

(22) Filed: Jan. 11, 2022

(51) Int. Cl. G01C 21/34; B60W 60/00

(52) U.S. Cl. CPC G01C 21/3407; B60W 60/001; B60W 2556/50

(57) ABSTRACT

Provided are methods for graph exploration for rulebook trajectory generation. Some methods described include generating a next set of alternative trajectories for the vehicle from a next pose, the next set of alternative trajectories representing operation of the vehicle from the next pose, wherein the next pose is located at an end of an identified trajectory. Next trajectories are iteratively identified from corresponding next sets of alternative trajectories, wherein a next trajectory violates a lowest behavioral rule of the hierarchical plurality of rules, the lowest behavioral rule having a priority less than a priority of behavioral rules associated with other trajectories in a corresponding next set of alternative trajectories until a goal pose or timeout is reached to generate a graph. Systems and computer program products are also provided.

### BACKGROUND

Operation of a vehicle from an initial location to a final destination often requires a user or a vehicle’s decision-making system to select a route through a road network from the initial location to a final destination. The route may involve meeting objectives, such as not exceeding a maximum driving time. Moreover, vehicles may be required to meet complex specifications imposed by traffic laws and the cultural expectations of driving behavior. Thus, operation of an autonomous vehicle can require many decisions, making traditional algorithms for autonomous driving impractical.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4 is a diagram of certain components of an autonomous system;

FIG. 5 are diagrams of an implementation of a process for graph exploration for rulebook trajectory generation;

FIG. 6 illustrates an example scenario for autonomous vehicle operation using graph exploration with behavioral rule checks;

FIG. 7 illustrates an example flow diagram of a process for vehicle operation using behavioral rule checks to determine a fixed set of trajectories;

FIG. 8 is an illustration of iteratively growing graphs to find an optimal trajectory after-the-fact;

FIG. 9 is a diagram of system that calculates scores according to rulebooks;

FIG. 10 is a flowchart of a process for graph exploration for rulebook trajectory generation.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

In some aspects and/or embodiments, systems, methods, and computer program products described herein include and/or implement graph exploration for rulebook trajectory generation. In examples, a vehicle (such as an autonomous vehicle) navigates an environment in accordance with a trajectory. The present techniques enable a determination of optimal trajectories in a given scenario (e.g., a predetermined environment with a set of fixed trajectories) using graph exploration. For a series of poses, the present techniques iteratively identify next trajectories from corresponding sets of alternative trajectories. A next trajectory is selected that violates a lowest behavioral rule of the hierarchical plurality of rules, the lowest behavioral rule having a priority less than a priority of behavioral rules associated with other trajectories in a corresponding next set of alternative trajectories, until a goal pose (e.g., destination) is reached. For ease of description, several rules with varying hierarchical priorities are described herein. However, the present techniques are not limited to the particular rules, rule priorities, and rule hierarchies as described herein. The particular rules are for exemplary purposes and should not be viewed as limiting.

By virtue of the implementation of systems, methods, and computer program products described herein, techniques enable graph exploration for rulebook trajectory generation that determines optimal trajectories in complex, dynamic scenarios. Some of the advantages of these techniques include determining an optimal trajectory in scenarios that are difficult to navigate. The present techniques generate an optimal trajectory without a baseline trajectory. As a result, the optimal trajectory is identified from a larger, more robust set of trajectories, and is an unconstrained trajectory (e.g., is not constrained by a baseline trajectory). Additionally, the present techniques reduce the computational resources used to determine an optimal trajectory based on the graph.

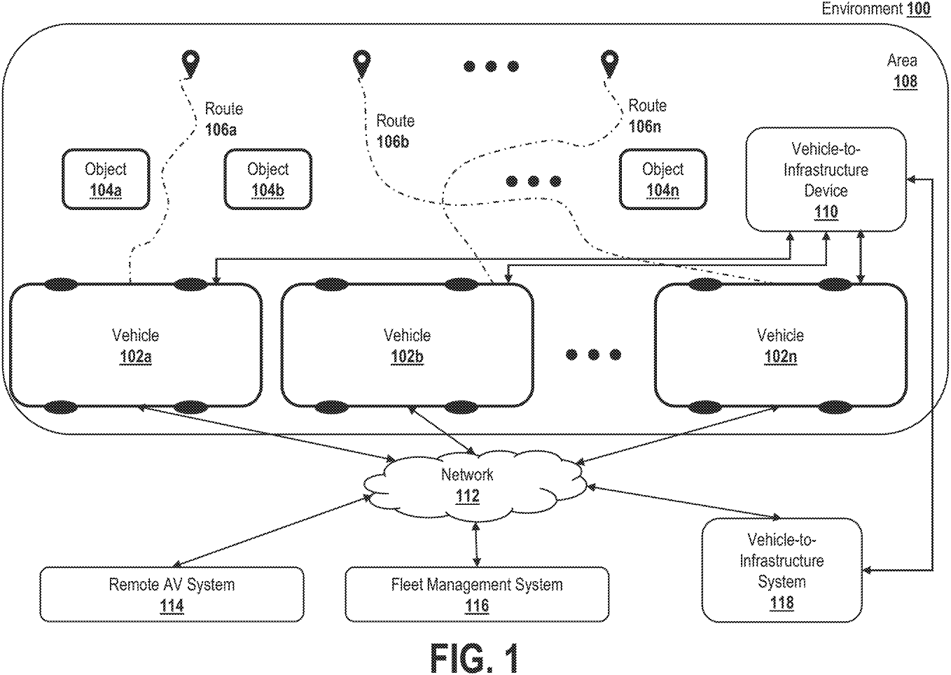

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

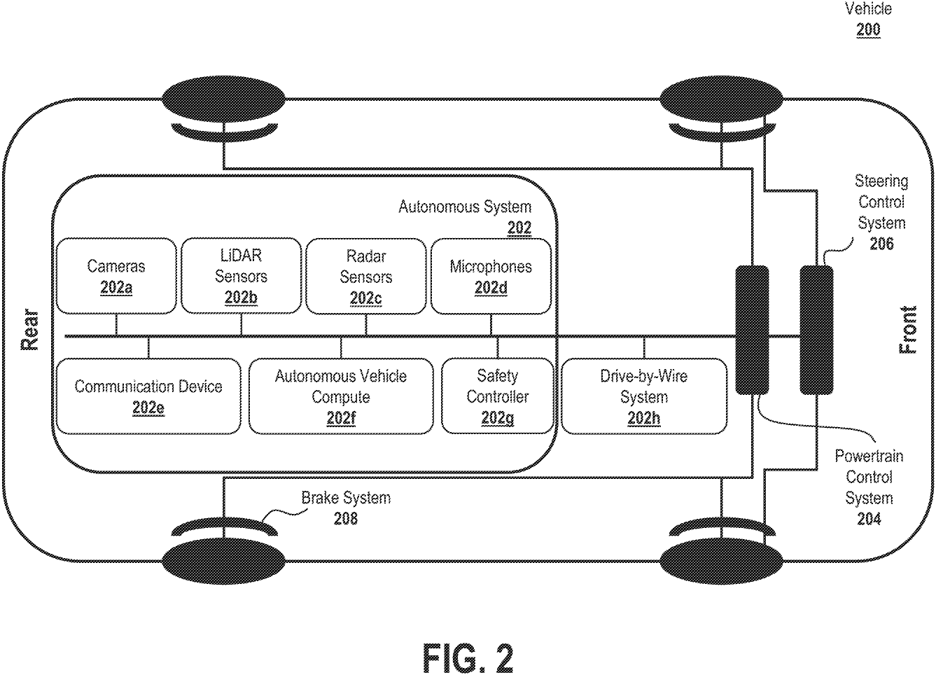

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, remote AV system 114, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 includes autonomous system 202, powertrain control system 204, steering control system 206, and brake system 208. In some embodiments, vehicle 200 is the same as or similar to vehicle 102 (see FIG. 1). In some embodiments, vehicle 102 have autonomous capability (e.g., implement at least one function, feature, device, and/or the like that enable vehicle 200 to be partially or fully operated without human intervention including, without limitation, fully autonomous vehicles (e.g., vehicles that forego reliance on human intervention), highly autonomous vehicles (e.g., vehicles that forego reliance on human intervention in certain situations), and/or the like). For a detailed description of fully autonomous vehicles and highly autonomous vehicles, reference may be made to SAE International’s standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, and drive-by-wire (DBW) system 202h.

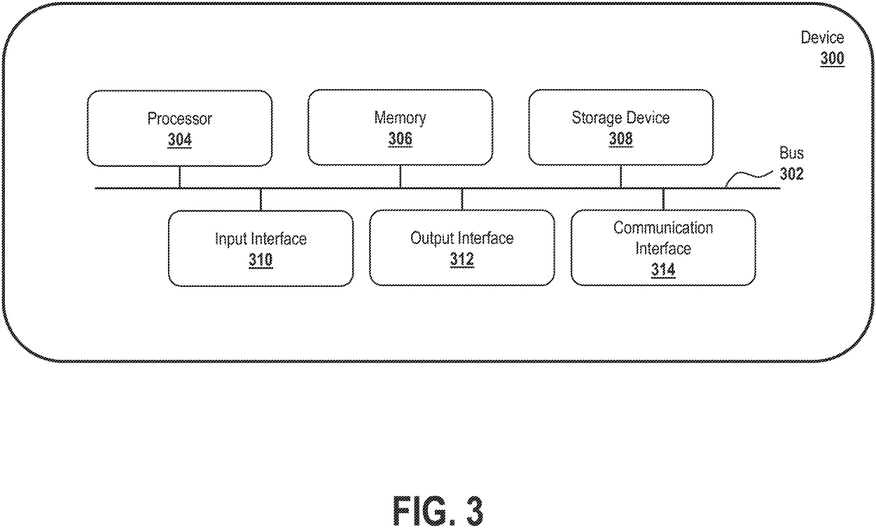

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a charge-coupled device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Laser Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum. In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e include at least one device configured to be in communication with cameras 202a, LiDAR sensors 202b, radar sensors 202c, microphones 202d, autonomous vehicle compute 202f, safety controller 202g, and/or DBW system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like) a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to start moving forward, stop moving forward, start moving backward, stop moving backward, accelerate in a direction, decelerate in a direction, perform a left turn, perform a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102) and/or one or more devices of network 112 (e.g., one or more devices of a system of network 112). In some embodiments, one or more devices of vehicles 102 (e.g., one or more devices of a system of vehicles 102) and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some embodiments, processor 304 is implemented in hardware, software, or a combination of hardware and software. In some examples, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

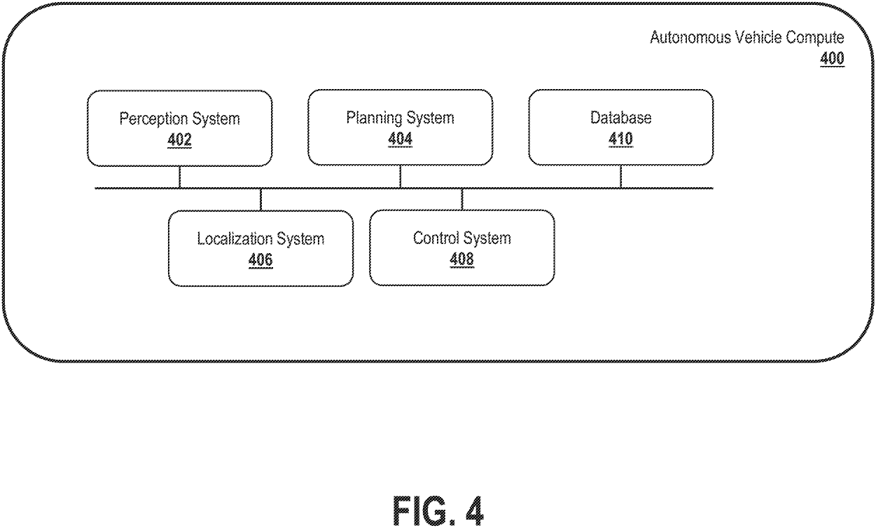

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits [ASICs], Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like).

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

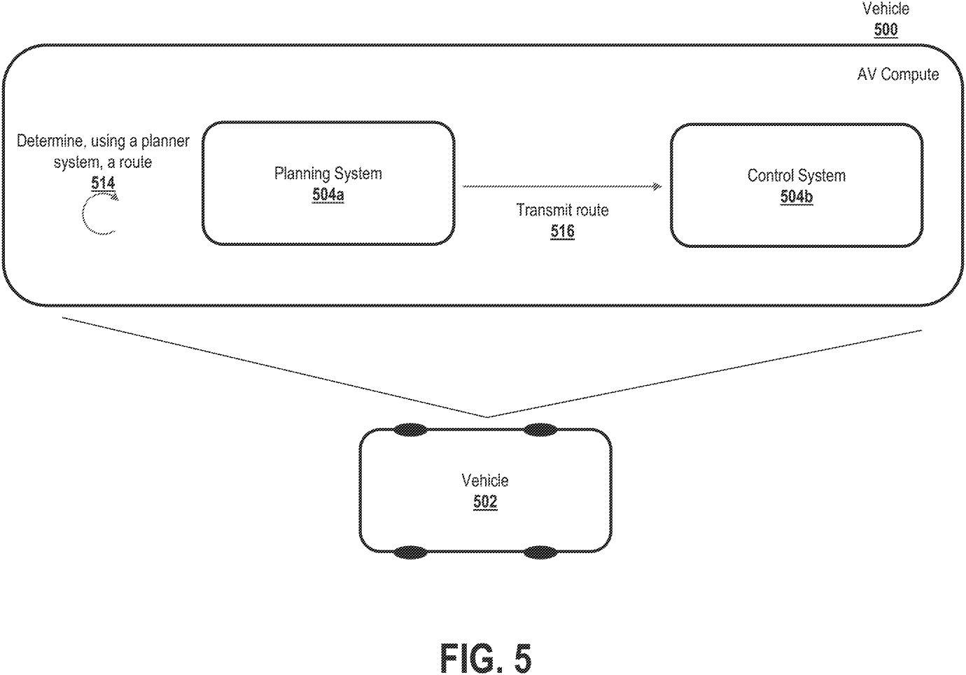

Referring now to FIG. 5, illustrated is a diagram of an implementation 500 of a process for graph exploration for rulebook trajectory generation. In some embodiments, implementation 500 includes planning system 504a. In some embodiments, planning system 504a is the same as or similar to planning system 404 of FIG. 4. In general, the output of a planning system 504a is a route from a start point (e.g., source location or initial location) to an end point (e.g., destination or final location). Accordingly, in the example of FIG. 5 the route is transmitted at reference number 516 to a control system 504b. During vehicle operation, the control system operates the vehicle to navigate the route. In embodiments, the route and other AV compute data is stored for after-the fact evaluation of routes selected by the AV to navigate from a start point to an end point. Generally, the route is defined by one or more segments. For example, a segment is a distance to be traveled over at least a portion of a street, road, highway, driveway, or other physical area appropriate for automobile travel. In some examples, e.g., if the AV is an off-road capable vehicle such as a four-wheel-drive (4WD) or all-wheel-drive (AWD) car, SUV, pick-up truck, or the like, the route includes “off-road” segments such as unpaved paths or open fields.

In addition to a route, a planning system 504a also outputs lane-level route planning data. The lane-level route planning data is used to traverse segments of the route based on conditions of the segment at a particular time. In embodiments, the lane-level route planning data is stored for after-the-fact evaluation using graph exploration as described herein. During operation, the lane-level route planning data is used to traverse segments of the route based on conditions of the segment at a particular time. For example, if the route includes a multi-lane highway, the lane-level route planning data includes trajectory planning data that the AV can use to choose a lane among the multiple lanes, e.g., based on whether an exit is approaching, whether one or more of the lanes have other vehicles, or other factors that vary over the course of a few minutes or less as the vehicle moves along a route. Similarly, in some implementations, the lane-level route planning data includes speed constraints specific to a segment of the route. For example, if the segment includes pedestrians or un-expected traffic, the speed constraints may limit the AV to a travel speed slower than an expected speed, e.g., a speed based on speed limit data for the segment.

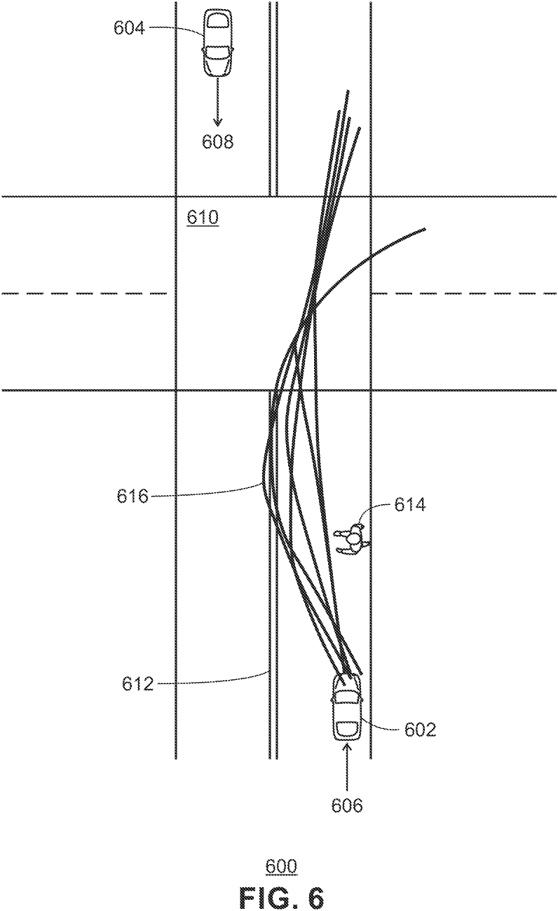

FIG. 6 illustrates an example scenario for AV 602 operation using graph exploration with behavioral rule checks, in accordance with one or more embodiments. The AV 602 may be, for example a vehicle 102 as illustrated and described in more detail with reference to FIG. 1 or a vehicle 200 as illustrated and described in more detail with reference to FIG. 2. The AV 602 operates in an environment 600, which may be an environment 100 as illustrated and described in more detail with reference to FIG. 1. In the example scenario illustrated in FIG. 6, the AV 602 is operating in lane 606 on approach to the intersection 610. Similarly, another vehicle 604 is operating in lane 608 on approach to the intersection 610. The flow of traffic in lane 606 is opposite to the flow of traffic in lane 608, as indicated by the arrows. There is a double line 612 separating lane 606 from lane 608. However, there is no physical road divider or median separating lane 606 from lane 608. The traffic rules in the environment 600 prohibit a vehicle from crossing the double line 612 or exceeding a predetermined speed limit (e.g., 45 miles per hour) in accordance with generally understood rules of the road.

The AV 602 is operating in the lane 606 to a destination beyond the intersection 610. As illustrated, a pedestrian 614 is located in the lane 606, blocking the lane 606. Other objects can block the AV’s planned trajectory, such as incidents that block a lane of travel, vehicle breakdowns, construction, cyclists, and the like. In embodiments, the AV 602 uses a perception system 402 to identify the objects, such as the pedestrian 614. The perception system 402 is illustrated and described in more detail with reference to FIG. 4. Generally, the perception system 402 classifies objects into types such as automobile, roadblock, traffic cones, etc. The objects are provided to the planning system 404. The planning system 404 is illustrated and described in more detail with reference to FIG. 4.

The AV 602 determines that the lane 606 is blocked by the pedestrian 614. In examples, the AV 602 detects the boundaries of the pedestrian 614 based on characteristics of data points (e.g., sensor data) detected by the sensors 202 of FIG. 2. To reach the destination, a planning system 404 (FIG. 4) of the AV 602 generates the trajectories 616. Operating the AV 602 in accordance with the trajectories 616 causes the AV 602 to violate a traffic rule and cross the double line 612 to maneuver around the pedestrian 614 so that the AV 602 reaches its destination. Some of the trajectories 616 cause the AV 602 to cross the double line 612 and enter lane 608, in the path of the vehicle 604. The AV 602 uses a hierarchical set of rules of operation to provide feedback on the AV 602′s driving performance. The hierarchical set of rules is sometimes referred to as a stored behavioral model or a rulebook. In some embodiments, the feedback is provided in a pass-fail manner. The embodiments disclosed herein detect when the AV 602 (e.g., the planning system 404 of FIG. 4) generates trajectories 616 that violate behavioral rules, and determines that the AV 602 could have generated an alternative trajectory that would have violated lower-priority behavioral rules. The occurrence of such a detection denotes a failure of the motion planning process. The present techniques use graph exploration to heuristically determine the optimal trajectories 616 that navigate past the pedestrian 614 in lane 606 and reach a destination (e.g., goal). In embodiments, the optimal trajectory is a trajectory that begins at a starting pose and violates the lowest priority behavioral rules when compared with other trajectories.

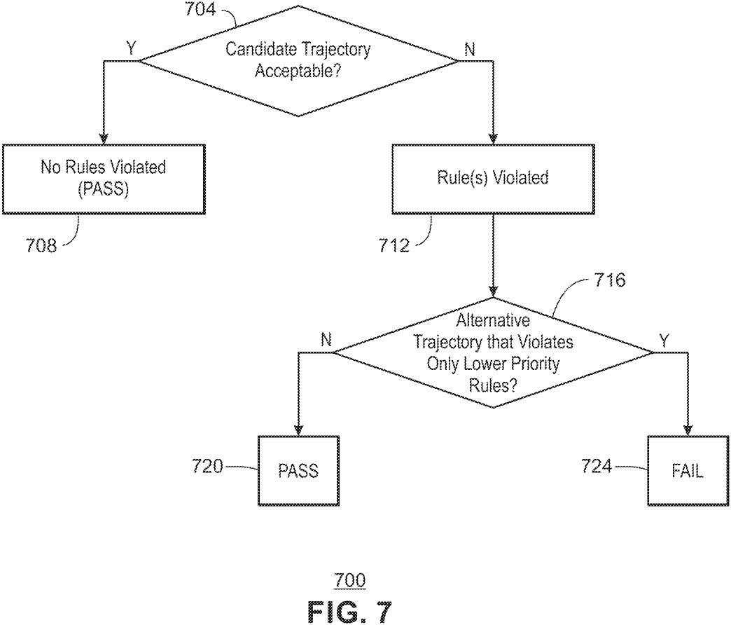

In embodiments, at least one processor receives sensor data after the operation of the AV. The sensor data is representative of scenarios encountered by the AV while navigating through the environment. Hierarchical rules are applied to scenarios simulated by an AV stack to modify and improve the AV development after-the-fact (e.g., after operation of the AV, where sensor data is captured). In examples, this offline framework is configured to develop a transparent and reproducible rule-based pass/fail evaluation of AV trajectories in test scenarios. For example, in an offline framework, a given trajectory output by the planning system 404 is rejected if a trajectory that leads to a lesser violation of the rule priority structure is found. The planning system is modified and improved based on, at least in part, the rejected trajectory and data associated with the rejected trajectory. In embodiments, the present techniques receive a fixed set of trajectories generated after-the-fact from a given scenario and determines an optimal trajectory to evaluate if the AV passes or fails a predetermined test. The present techniques use a set of fixed trajectories to create a graph. In embodiments, the graph is an edge weighted graph, wherein weights are assigned to edges that correspond to trajectories based on rule violations. Each trajectory is associated with one or more costs, each cost corresponding to a rule violation. Determining the fixed set of trajectories is described with respect to FIG. 7.

FIG. 7 illustrates an example flow diagram of a process 700 for vehicle operation using behavioral rule checks to determine a fixed set of trajectories. In embodiments, the process of FIG. 7 is performed by the AV 200 of FIG. 2, the device 300 of FIG. 3, the AV compute 400 of FIG. 4, or any combinations thereof. In embodiments, at least one processor located remotely from a vehicle performs the process 700 of FIG. 7. Likewise, embodiments may include different and/or additional steps, or perform the steps in different orders.

At block 704, it is determined that a trajectory (e.g., trajectories 616) for the AV 602 is acceptable. The trajectories 616 and AV 602 are illustrated and described in more detail with reference to FIG. 600. In examples, a trajectory is determined to be acceptable based on violation of behavioral rules in a hierarchical set of rules of operation of the AV 602. If no rules are violated, the process moves to step 708 and the planning system 404 and AV behavior pass the verification checks. The planning system 404 is illustrated and described in more detail with reference to FIG. 4.

At block 704, if a rule is violated, the process moves to block 712. The violated rule is denoted as a first behavioral rule having a first priority. The process moves to block 716. At block 716, the processor determines whether an alternative less-violating trajectory exists. For example, the processor generates multiple alternative trajectories for the AV 602 based on sensor data associated with a scenario. In embodiments, the sensor data characterizes information associated with the AV, information associated with the objects, information associated with the environment, or any combinations thereof. The processor identifies whether there exists a second trajectory that violates only a second behavioral rule of the hierarchical set of rules, such that the second behavioral rule has a second priority less than the first priority. In examples, if no other trajectory exists that violates only a second behavioral rule having a lower priority than the first priority, the process moves to block 720. The planning system 404 and AV behavior pass the verification checks. At block 716, an alternative less-violating trajectory exists, the planning system 404 and AV behavior fail the verification checks.

In examples, an AV is operable according to a number of hierarchical behavioral rules. Each behavioral rule has a priority with respect to each other rule. For example, a rulebook can include the following rules, in increasing order of priority: 1: maintain a predetermined speed limit; 2: stay in lane; 3: maintain a predetermined clearance; 4: reach goal; 5: avoid collisions. In examples, the priority represents a risk level of a violation of the behavioral rules. The rulebook is therefore a formal framework to specify driving requirements enforced by traffic laws or cultural expectations as well as their relative priorities. The rulebook is a pre-ordered set of rules having violation scores that capture the hierarchy of the rule priorities. Hence, the rulebook enables AV behavior specification and assessment in conflicting scenarios.

Referring again to FIG. 6, consider the case where a pedestrian 614 enters the lane in which the AV 602 is traveling. A reasonable AV behavior is to avoid collision with the pedestrian 614 and other vehicle 604 (e.g., satisfy rule 5: avoid collision, highest priority in the exemplary rulebook), although at the cost of violating lower priority rules, such as reducing speed to less than a minimum speed limit (e.g., violation of rule 1: maintain a predetermined speed limit) or deviating from a lane (e.g. violation of rule 2: stay in lane). Rulebook generation is an after-the-fact prioritization of actions the AV should take based on perfect information (e.g., knowing predetermined values or states) associated with the scenario. In an embodiment, violating a behavioral rule includes operating the AV such that the AV exceeds a predetermined speed limit (e.g., 45 mph). For example, the rule 1: maintain a predetermined speed limit denotes that the AV should not violate the speed limit of the lane it is traveling in. However, rule (1) is a lower priority rule; hence, the AV may violate rule (1) in order to prevent a collision (e.g., with another vehicle) and act in accordance with rule 5: avoid collisions. In an embodiment, violating a behavioral rule includes operating the AV such that the AV stops before reaching a destination. In examples, rule 2: stay in lane denotes that the AV should stay in its own lane. The priority of rule (2) is lower than the priority of rule 5: avoid collisions. Hence the AV violates only rule 2: stay in lane to satisfy rule 5: avoid collisions, rule 4: reach goal, and rule 3: maintain clearance.

In an embodiment, a violation of the stored behavioral rules of operation of the AV includes operating the AV such that a lateral clearance between the AV and the objects near the AV decreases below a threshold lateral distance. For example, rule 3: maintain a predetermined clearance denotes that the AV should maintain a threshold lateral distance (e.g., one half car length or 1 meter) from any other object (e.g., pedestrian 614). However, in this example the priority of rule 3: maintain a predetermined clearance is lower than the priority of rule 4: reach destination. Hence, as illustrated and described in more detail with reference to FIG. 6, the AV may violate rule (3) to obey the higher priority rules 4: reach goal and 5: avoid collisions.

In embodiments, the sets of alternative trajectories are generated based on human driving behavior. In embodiments, the trajectories come from safety driver sets, or by training on a set of trajectories obtained from human drivers. The trajectories exist in a plurality of sets, and are stitched together to generate a graph of trajectories. In embodiments, the trajectory sets represent all possible trajectories the AV can take with respect to a starting pose. Accordingly, the trajectories are those routes that are possible in view of a predetermined speed or heading (e.g., pose).

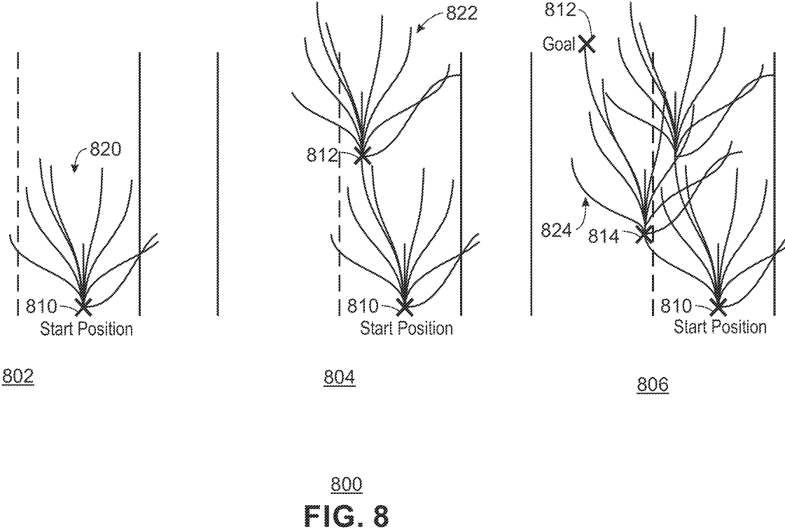

FIG. 8 is an illustration of iteratively growing graphs 800 to find an optimal trajectory after-the-fact. In embodiments, the generated graphs 802, 804, and 806 are explored to find an optimal trajectory that represents a reasonable path for the vehicle through an environment. The reasonable path can be used to compare a trajectory taken by the AV in a same scenario associated with the optimal trajectories according to the present techniques. The graph generation enables evaluation of an AV response in view of a quickly generated optimal trajectory.

In embodiments, determining an optimal after-the-fact trajectory with a known scenario (e.g., with perfect information) changes as the trajectory develops. Put another way, a trajectory that is optimal at a first pose might not remain optimal at subsequent poses. For example, during travel through an environment the AV can get stuck (e.g., unable to plan a path forward) or left to follow a path that creates a clearance violation (e.g., violation of a hierarchical rule of a rulebook). In some cases, trajectories are generated without positive reinforcement of selected (e.g., traversed or navigated) trajectories as the AV travels. In traditional techniques, generated trajectories can deteriorate over time. The present techniques evaluates candidate trajectories at a series of poses, such that a subset of optimal trajectories at a series of poses are selected according to the rulebooks. The trajectories are iteratively traversed to generate a graph of optimal trajectories from a starting pose to a goal pose. The present techniques create a graph based on the fixed set of trajectories. In embodiments, the generated graph captures vehicular dynamics from the fixed trajectory sets using the series of poses.

In the example of FIG. 8, a first pose 810 of the AV is at the start position. From the start position, a set of alternative trajectories 820 for a vehicle at a first pose 810 (e.g., root node of the corresponding graph) are generated, the set of alternative trajectories representing operation of the vehicle from the first pose 810. In the set of alternative trajectories, one or more optimal trajectories are determined. The optimal trajectories are used to determine next poses, and a set of alternative trajectories 822 and 824 are generated from next poses. In particular, a next pose 812 is evaluated to generate a set of alternative trajectories 822. A next pose 814 is evaluated to generate a set of alternative trajectories 824. In embodiments, sets of alternative trajectories are iteratively generated until the goal/destination 812 is reached.

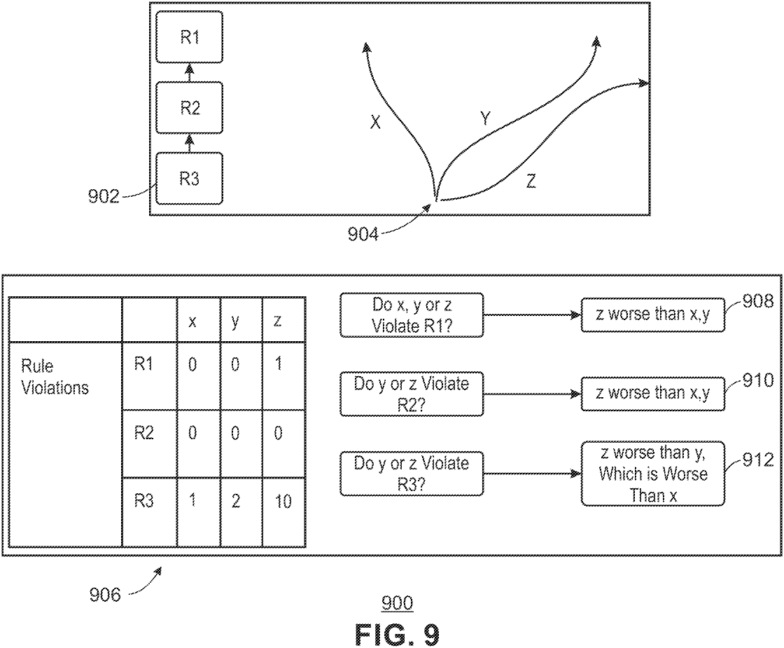

As illustrated in FIG. 8, the graphs 802, 804, and 806 are generated by calculating a set of alternative trajectories at a first pose 810 of AV in a given scenario. From the set of alternative trajectories 820, a random subset of N1 trajectories are determined. The trajectories kept for the graph are the trajectories that are most likely to lead to a best, optimal trajectory. In examples, N2 trajectories that score best according to the rulebooks at a current time stamp are selected for the graph. For example, a preordered list of scores according to the rule violations is associated with each edge of the graph. This score is described below with respect to FIG. 9. Generally, the values of N1 and N2 are selected for graph growing to enable tuning of the quality of the graph when compared to the speed of computing the graph. Larger values of N1 and N2 can cause exponential increases in computation time, however the quality of the resulting graph also increases.

In embodiments, the N2 trajectories are grown with N1 more trajectories. For example, a next pose (e.g., next pose 812, 814) at the end of the selected N2 trajectories from the set of alternative trajectories 820 are used to iteratively generate another random subset of N1 trajectories. Again, the trajectories that are retained are the ones that are most likely to lead to an optimal trajectory (e.g., N2 trajectories). Graph growth continues until one or more trajectories are generated that reach the goal 812 or a timeout occurs. The timeout may be a predetermined period of time before graph generation is terminated. In examples, the timeout can be canceled or overridden to continue graph generation. The trajectories selected for the graph are those trajectories from the first pose to the goal that have a lowest score according to the rulebooks.

FIG. 9 is a diagram of system 900 that calculates scores according to rulebooks. In the example of FIG. 9, a rulebook 902 provides three exemplary hierarchical rules: R1 (highest priority), R2 (next highest priority), R3 (lowest priority). Additionally, a fixed set of trajectories 904 includes a trajectory x, trajectory y, and trajectory z. The fixed set of trajectories may be the trajectories 616 (FIG. 6) or trajectories 820, 822, or 824 of FIG. 8. In embodiments, the fixed set of trajectories represent reasonable actions that vehicles make in most traffic situations. In examples, the fixed set of trajectories is generated using a planning system of an AV (e.g., planning system 404 of FIG. 4) in response to simulation in a predetermined scenario. In examples, the predetermined scenario is represented by AV compute inputs and outputs as the AV travels from a starting pose.

In the example of FIG. 9, rule violations for each trajectory of the fixed set of trajectories are used to determine rule violation scores 906 for each trajectory. In particular, each rule is evaluated to determine the rule violation scores for a trajectory. At evaluation 908, rule R1 is evaluated to determine if trajectory x, trajectory y, or trajectory Z violates rule R1. In the example of FIG. 9, trajectory z violates rule R1, while trajectory x and trajectory y do not violate rule R1. Trajectory z is assigned a score of 1 with respect to rule R1. Trajectories x and y are assigned a score of 0 with respect to rule R1. At evaluation 910, rule R2 is evaluated to determine if trajectory x, trajectory y, or trajectory Z violates rule R2. In the example of FIG. 9, no trajectory violates rule R2. Each trajectory is assigned a score 0 with respect to rule R2.

In some embodiments, a score represents a comparative level of rule a violation for all trajectories. Each individual rule is independently evaluated with respect to each individual trajectory. The value of each score is based on, at least in part, the rule under evaluation. Put another way, the scores are computed in different ways according to the rule being evaluated. For example, for a rule that maintains clearance near a pedestrian, a score is the maximum of the number of instantaneous violations of clearance associated with that pedestrian. In this example, the violations are entering a space near the pedestrian by exceeding a threshold distance to the pedestrian. Each trajectory is ranked based on the number of violations according to a lexicographic order. Accordingly, at evaluation 908 trajectory z is the only trajectory that violates R1, so that makes it the worst trajectory. At evaluation 902, no trajectory violates rule R2 such that no trajectory is worse that the other trajectories with respect to R2.

At evaluation 912, rule R3 is evaluated to determine if trajectory x, trajectory y, or trajectory z violates rule R3. In the example of FIG. 9, trajectory z violates rule R3 worse than trajectory y, which in turn violates rule R3 worse than trajectory x. Trajectory z is assigned a score of 10 with respect to rule R3, where 10 is the maximum number of violations of rule R3. Trajectory x is assigned a score of 1, and trajectory y is assigned a score of 2 with respect to rule R3.

Generally, from the set of fixed trajectories, a random subset of N1 trajectories are determined. The trajectories kept for the graph are the trajectories have a score above a predetermined threshold. In examples, N2 trajectories that score above the predetermined threshold according to the rulebooks are selected for the graph. In embodiments, these N2 trajectories are grown with N1 more trajectories. Generally, growing a graph refers to generating a next set of random trajectories from an ending pose of an N2 trajectory (e.g., trajectories that score above a predetermined threshold) from the prior set of fixed trajectories. Graph growth continues until one or more trajectories are generated that reach the goal pose. The trajectories selected for the graph are those trajectories from the first pose to the goal pose that have a lowest score according to the rulebooks. In this manner, the graph is generated as a guided heuristic that uses the behavior modeling and prediction data set to create a graph. In examples, the present techniques do not converge on a singular optimal trajectory. The present techniques obtain a reasonable optimal trajectory as distinguished from convergence to a singular optimal trajectory.

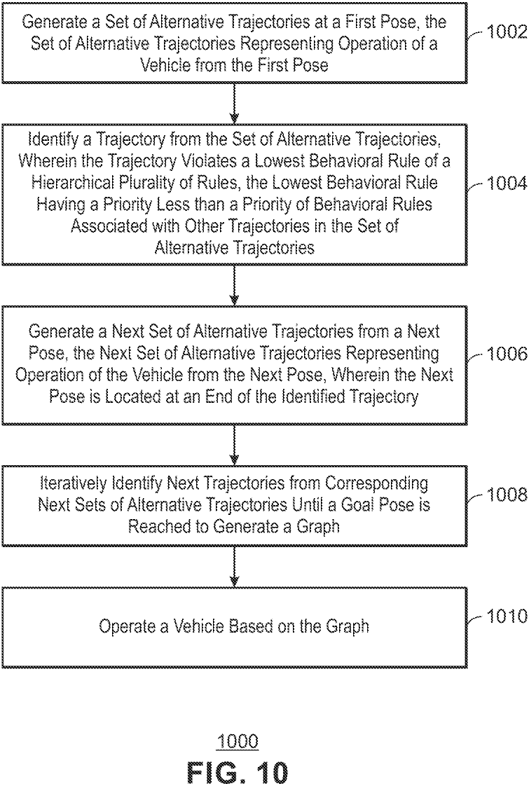

Referring now to FIG. 10, illustrated is a flowchart of a process 1000 for graph exploration for rulebook trajectory generation. In some embodiments, one or more of the steps described with respect to process 1000 are performed (e.g., completely, partially, and/or the like) by autonomous vehicle 200 of FIG. 2 or AV computer 400 of FIG. 4. Additionally, or alternatively, in some embodiments one or more steps described with respect to process 1000 are performed (e.g., completely, partially, and/or the like) by another device or group of devices separate from or including autonomous system 400 such as device 300 of FIG. 3.

At block 1002, a set of alternative trajectories for a vehicle at a first pose are generated. In embodiments, the alterative trajectories are sets of trajectories generated using behavior prediction. In embodiments, the first pose is a root node of the corresponding graph. The set of alternative trajectories represent operation of the vehicle from the first pose.

At block 1004, a trajectory from the set of alternative trajectories is identified. In embodiments, the trajectory violates a lowest behavioral rule of a hierarchical plurality of rules, the lowest behavioral rule having a priority less than a priority of behavioral rules associated with other trajectories in the set of alternative trajectories. Accordingly, in embodiments the present techniques select the one or more trajectories at the root node that appear to be optimal trajectories.

At block 1006, a next set of alternative trajectories is generated from a next pose responsive to identifying the trajectory. The next set of alternative trajectories represents operation of the vehicle from the next pose. In examples, the next pose is located at an end of the identified trajectory. In this manner, the graph is iteratively grown based on the next pose resulting from the identified trajectory. The next set of alternative trajectories for the vehicle may be generated from the next pose by applying vehicle dynamics associated with the next pose to possible trajectories associated with a location of the next pose. Vehicle dynamics include, for example, speed and orientation associated with the trajectory at the next pose.

At block 1008, next trajectories from corresponding next sets of alternative trajectories are iteratively identified. In embodiments, a next trajectory violates a lowest behavioral rule of the hierarchical plurality of rules, the lowest behavioral rule having a priority less than a priority of behavioral rules associated with other trajectories in a corresponding next set of alternative trajectories until a goal pose is reached to generate a graph. Put another way, in some embodiments the present techniques iteratively repeat steps of identifying an optimal trajectory at a series of poses until the goal pose is reached. In some embodiments the optimal trajectory does not reach a goal pose, and the present techniques iteratively repeat steps of identifying an optimal trajectory at a series of poses until a predetermined timeout occurs. In examples, the optimal trajectory is the trajectory that violates the lowest priority behavioral rules when compared with other trajectories, where the trajectories are ranked according to rule violations. Growing the graph generally continues until a set of trajectories are identified from the first pose as described above. At block 1010, a vehicle is operated based on the graph. In examples, vehicle operation based on the graph includes extracting optimal trajectories from the graph and comparing a trajectory taken by a vehicle to the optimal trajectories. In this manner, performance of the vehicle is evaluated in view of an optimal trajectory. The optimal trajectories extracted by the graph are used to provide feedback on vehicle performance.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/subentity of a previously-recited step or entity.

1. A method comprising:
generating, with at least one processor, a set of alternative trajectories for a vehicle at a first pose, the set of alternative trajectories representing operation of the vehicle from the first pose;
identifying, with the at least one processor, a trajectory from the set of alternative trajectories, wherein the trajectory violates a lowest behavioral rule of a hierarchical plurality of rules, the lowest behavioral rule having a priority less than a priority of behavioral rules associated with other trajectories in the set of alternative trajectories;
responsive to identifying the trajectory, generating, with the at least one processor, a next set of alternative trajectories for the vehicle from a next pose, the next set of alternative trajectories representing operation of the vehicle from the next pose, wherein the next pose is located at an end of the identified trajectory;
iteratively identifying, with the at least one processor, next trajectories from corresponding next sets of alternative trajectories, wherein a next trajectory violates a lowest behavioral rule of the hierarchical plurality of rules, the lowest behavioral rule having a priority less than a priority of behavioral rules associated with other trajectories in a corresponding next set of alternative trajectories until a goal pose or timeout is reached to generate a graph; and
transmitting, by the at least one processor, a message to a control system of the vehicle to operate the vehicle based on the graph.

2. The method of claim 1, further comprising pruning, with the at least one processor, trajectories from the set of alternative trajectories or the next set of alternative trajectories based on a likelihood of being an optimal trajectory.

3. The method of claim 1, further comprising pruning, with the at least one processor, trajectories from the set of alternative trajectories or the next set of alternative trajectories based on a trajectory remaining on a roadway.

4. The method of claim 1, further comprising identifying, with the at least one processor, the trajectory or the next trajectories using at least one of minimum-violation planning, model predictive control, or machine learning, the identifying based on the hierarchical plurality of rules.

5. The method of claim 1, wherein each behavioral rule of the hierarchical plurality of rules has a respective priority with respect to each other behavioral rule of the hierarchical plurality of rules.

6. The method of claim 1, further comprising generating, with the at least one processor, the next set of alternative trajectories for the vehicle from the next pose by applying vehicle dynamics associated with the next pose to possible trajectories associated with a location of the next pose.

7. The method of claim 1, further comprising assigning, with the at least one processor, a rule violation value to trajectories of the set of alternative trajectories or the next set of alternative trajectories, wherein the rule violation values represent weights associated with the trajectories in the graph.

8. A system, comprising:
at least one processor, and
at least one non-transitory storage media storing instructions that, when executed by the at least one processor, cause the at least one processor to:
generate a set of alternative trajectories for a vehicle at a first pose, the set of alternative trajectories representing operation of the vehicle from the first pose;
identify a trajectory from the set of alternative trajectories, wherein the trajectory violates a lowest behavioral rule of a hierarchical plurality of rules, the lowest behavioral rule having a priority less than a priority of behavioral rules associated with other trajectories in the set of alternative trajectories;
responsive to identifying the trajectory, generate a next set of alternative trajectories for the vehicle from a next pose, the next set of alternative trajectories representing operation of the vehicle from the next pose, wherein the next pose is located at an end of the identified trajectory;
iteratively identify next trajectories from corresponding next sets of alternative trajectories, wherein a next trajectory violates a lowest behavioral rule of the hierarchical plurality of rules, the lowest behavioral rule having a priority less than a priority of behavioral rules associated with other trajectories in a corresponding next set of alternative trajectories until a goal pose or timeout is reached to generate a graph; and
transmit a message to a control system of the vehicle to operate the vehicle based on the graph.

9. The system of claim 8, further comprising pruning, with the at least one processor, trajectories from the set of alternative trajectories or the next set of alternative trajectories based on a likelihood of being an optimal trajectory.

10. The system of claim 8, further comprising pruning, with the at least one processor, trajectories from the set of alternative trajectories or the next set of alternative trajectories based on a trajectory remaining on a roadway.

11. The system of claim 8, further comprising identifying, with the at least one processor, the trajectory or the next trajectories using at least one of minimum-violation planning, model predictive control, or machine learning, the identifying based on the hierarchical plurality of rules.

12. The system of claim 8, wherein each behavioral rule of the hierarchical plurality of rules has a respective priority with respect to each other behavioral rule of the hierarchical plurality of rules.

13. The system of claim 8, further comprising generating, with the at least one processor, the next set of alternative trajectories for the vehicle from the next pose by applying vehicle dynamics associated with the next pose to possible trajectories associated with a location of the next pose.

14. The system of claim 8, further comprising assigning, with the at least one processor, a rule violation value to trajectories of the set of alternative trajectories or the next set of alternative trajectories, wherein the rule violation values represent weights associated with the trajectories in the graph .

15. At least one non-transitory storage medium storing instructions that, when executed by at least one processor, cause the at least one processor to:
generate a set of alternative trajectories for a vehicle at a first pose, the set of alternative trajectories representing operation of the vehicle from the first pose;
identify a trajectory from the set of alternative trajectories, wherein the trajectory violates a lowest behavioral rule of a hierarchical plurality of rules, the lowest behavioral rule having a priority less than a priority of behavioral rules associated with other trajectories in the set of alternative trajectories;
responsive to identifying the trajectory, generate a next set of alternative trajectories for the vehicle from a next pose, the next set of alternative trajectories representing operation of the vehicle from the next pose, wherein the next pose is located at an end of the identified trajectory;
iteratively identify next trajectories from corresponding next sets of alternative trajectories, wherein a next trajectory violates a lowest behavioral rule of the hierarchical plurality of rules, the lowest behavioral rule having a priority less than a priority of behavioral rules associated with other trajectories in a corresponding next set of alternative trajectories until a goal pose or timeout is reached to generate a graph; and
transmit a message to a control system of the vehicle to operate the vehicle based on the graph.

16. The at least one non-transitory storage medium of claim 15, further comprising pruning, with the at least one processor, trajectories from the set of alternative trajectories or the next set of alternative trajectories based on a likelihood of being an optimal trajectory.

17. The at least one non-transitory storage medium of claim 15, further comprising pruning, with the at least one processor, trajectories from the set of alternative trajectories or the next set of alternative trajectories based on a the trajectory remaining on a roadway.

18. The at least one non-transitory storage medium of claim 15, further comprising identifying, with the at least one processor, the trajectory or the next trajectories using at least one of minimum-violation planning, model predictive control, or machine learning, the identifying based on the hierarchical plurality of rules.

19. The at least one non-transitory storage medium of claim 15, wherein each behavioral rule of the hierarchical plurality of rules has a respective priority with respect to each other behavioral rule of the hierarchical plurality of rules.

20. The at least one non-transitory storage medium of claim 15, further comprising generating, with the at least one processor, the next set of alternative trajectories for the vehicle from the next pose by applying vehicle dynamics associated with the next pose to possible trajectories associated with a location of the next pose.
